(19) United States
(12) Patent Application Publication
(10) Pub. No.: US 2014/0130624 A1
(43) Pub. Date: May 15, 2014

(54) TRANSMISSION DEVICE FOR AN EXIT DEVICE FOR A DOOR

(71) Applicant: Stanley Security Solutions Taiwan Ltd., Chia-Yi (TW)

(72) Inventors: Wei-Liang CHIANG, Chiayi City (TW); Kun-Chen LEE, Chiayi County (TW); You-Fang YE, Chiayi County (TW); Po-Yang CHEN, Chiayi City (TW)

(73) Assignee: Stanley Security Solutions Taiwan Ltd., Chia-Yi (TW)

(21) Appl. No.: 14/075,357

(22) Filed: Nov. 8, 2013

(30) Foreign Application Priority Data
Nov. 13, 2012 (TW) 101221887

(51) Int. Cl. E05C 9/08

(52) U.S. Cl. CPC E05C 9/08
USPC 74/104

(57) ABSTRACT

A transmission device for an exit device for a door includes a base (10) to which a transmission member (4) and a driving member (6) are pivotably mounted. A pushed section (611) of the driving member (6) abuts a push portion (421) of the transmission member (4). A link (7) is movably mounted to the base (10) and is connected to a latch of the exit device. When the transmission member (4) pivots from a first angular position to a second angular position, the push portion (421) of the transmission member (4) pushes the pushed section (611) of the driving member (6) to pivot the driving member (6) from a third angular position to a fourth angular position, and a push section (621) of the driving member (6) pushes a pushed portion (712) of the link (7) to move the link (7) for retracting the latch.

### CROSS REFERENCE TO RELATED APPLICATION

This application claims the priority of Taiwanese Utility Model Application No. 101221887, filed Nov. 13, 2012, the entire contents of which are herein incorporated by reference

### BACKGROUND OF THE INVENTION

The present invention relates to a transmission device for an exit device for a door and, more particularly, to a transmission device that can be actuated by pressing a press bar of an exit device for a door to simultaneously retract top and bottom latches for unlatching purposes.

Top and bottom latches for exit devices for doors are generally designed to be movable together with an operative device to provide operational convenience. Specifically, latch heads of the top and bottom latches are retracted when a press bar of the operative device is pressed. However, the operative device has a complicated structure and is, thus, difficult for the users to install.

Thus, a need exists for a simple-structured, easy-to-install transmission device that can be actuated by pressing the press bar of an exit device for a door to simultaneously retract the latch heads of the top and bottom latches for unlatching purposes.

### BRIEF SUMMARY OF THE INVENTION

The primary objective of the present invention is to provide a transmission device that can be actuated by pressing a press bar of an exit device for a door to simultaneously retract the latch heads of top and bottom latches for unlatching purposes.

In a first aspect of the present invention, a transmission device for an exit device for a door includes a base having an extension. A transmission member is pivotably mounted to the base and includes a push portion. The transmission member is pivotable relative to the base between a first angular pos ton and a second angular position. A driving member is pivotably mounted to the extension of the base. The driving member is pivotable relative to the base between a third angular position and a fourth angular position. The driving member includes a pushed section and a push section. The pushed section of the driving member abuts the push portion of the transmission member. A link is movably mounted to the base and is adapted to be connected to a latch of the exit device. The link is movable relative to the base between a first position and a second position. The latch is adapted to move between a latching position and an unlatching position respectively corresponding to the first and second positions of the link. The link includes a pushed portion located adjacent to the push section of the driving member.

When the transmission member pivots from the first angular position to the second angular position, the push portion of the transmission member pushes the pushed section of the driving member to pivot the driving member from the third angular position to the fourth angular position, and the push section of the driving member pushes the pushed portion the link to move the link from the first position to the second position.

Preferably, the base includes a slot, and the driving member includes a first end extend through the slot of the base. The first end of the driving member includes the pushed section of the driving member.

Preferably, the slot of the base includes aside, and the extension of the base extending from the side of the slot of the base. A pin extends through a hole of the driving member and a hole of the extension of the base to pivotably mount the driving member to the base.

Preferably, the transmission member includes a first plate and a second plate connected to and at an angle to the first plate. The second plate of the transmission member includes the push portion of the transmission member.

Preferably, the link includes a groove having a wall forming the pushed portion of the link. The driving member further includes a second end received in the groove of the link. The second end of the driving member includes the push section of the driving member.

Preferably, the link further includes a stop portion, and the base further includes an abutment portion. When the link is in the first position, the stop portion of the link abuts the abutment portion of the base. On the other hand, when the link is in the second position, the stop portion of the link does not abut the abutment portion of the base.

Preferably, the link includes an end having a screw hole. A screw extends through a hole of a rod into the screw hole of the link, fixing the rod to the end of the link. The rod is adapted to be connected to the latch.

Preferably, two limiting members are respectively mounted in two mounting holes of the base. Each limiting member includes a groove. The link includes two lateral sides respectively and movably received in the grooves of the limiting members,

Preferably, an actuating member is pivotably mounted to the base and includes an actuating portion. The transmission member includes an actuated portion. When the actuating member pivots through an angle, the actuating portion of the actuating member pushes the actuated portion of the transmission member to pivot the transmission member from the first angular position to the second angular position.

Preferably, the actuating member further includes a protrusion, and the base includes a guiding slot. The protrusion of the actuating member slides in the guiding slot when the actuating member pivots relative to the base.

In a second aspect of the present invention, a transmission device for an exit device for a door includes a base having an extension. A transmission member is pivotably mounted to the base and includes a push portion. The transmission member is pivotable relative to the base between a first angular position and a second angular position. A driving member is pivotably mounted to the extension of the base. The driving member is pivotable relative to the base between a third angular position and a fourth angular position. The driving member includes a pushed section and a push section. The pushed section of the driving member abuts the push portion of the transmission member. A link is movably mounted to the base and is adapted to be connected to a latch of the exit device. The link is movable relative to the base between a first position and a second position. The latch is adapted to move between a latching position and an unlatching position respectively corresponding to the first and second positions of the link. The link includes a pushed portion located adjacent to the push section of the driving member. At least one limiting member is mounted to the base and includes a groove. The link includes a lateral side movably received in the groove of the at least one limiting member.

When the transmission member pivots from the first angular position to the second angular position, the push portion of the transmission member pushes the pushed section of the driving member to pivot the driving member from the third angular position to the fourth angular position, and the push section of the driving member pushes the pushed portion of the link to move the link from the first position to the second position.

In a third aspect of the present invention, a transmission device for an exit device for a door includes a base including a slot having a side. An extension extends from the side of the slot of the base and has a hole. A transmission member is pivotably mounted to the base and includes a push portion. The transmission member is pivotable relative to the base between a first angular position and a second angular position. A driving member is pivotably mounted to the extension of the base. The driving member is pivotable relative to the base between a third angular position and a fourth angular position. The driving member includes a first end, a push section, and a hole, The first end of the driving member includes a pushed section and extends through the slot of the base. The pushed section of the driving member abuts the push portion of the transmission member. A pin extends through the hole of the driving member and the hole of the extension of the base to pivotably mount the driving member to the base. A link is movably mounted to the base and is adapted to be connected to a latch of the exit device. The link is movable relative to the base between a first position and a second position. The latch is adapted to move between a latching position and an unlatching position respectively corresponding to the first and second positions of the link. The link includes a pushed portion located adjacent to the push section of the driving member. At least one limiting member is mounted to the base and includes a groove. The link includes lateral side movably received in the groove of the at least one limiting member.

When the transmission member pivots from the first angular position to the second angular position, the push portion of the transmission member pushes the pushed section of the driving member to pivot the driving member from the third angular position to the fourth angular position, and the push section of the driving member pushes the pushed portion of the link to move the link from the first position to the second position.

The present invention will become clearer in light of the following detailed description of illustrative embodiments of this invention described in connection with the drawings.

### DESCRIPTION OF THE DRAWINGS

FIG. 1 is an exploded, perspective view of a transmission device for an exit device for a door of an embodiment according to the present invention.

FIG. 2 is a perspective view of an upper base of the transmission device of FIG. 1.

FIG. 3 is a perspective view of a transmission member of the transmission device of FIG. 1.

FIG. 4 is a perspective view of one of two driving members of the transmission device of FIG. 1.

FIG. 5 is a perspective view of one of two links of the transmission device of FIG. 1.

FIG. 6 is a perspective view an actuating member of the transmission device of FIG. 1.

FIG. 7 is a perspective view of the transmission device of FIG. 1, with the transmission member and the links in an angular position, and with the links in a first position.

FIG. 8 is a cross sectional view taken along section line 8-8 of FIG. 7,

FIG. 9 is a perspective view similar to FIG. 7, with the transmission member and the links moved to another angular position, and with the links moved to a second position.

FIG. 10 is a cross sectional view taken along section line 10-10 of FIG. 9.

FIG. 11 is a perspective view similar to FIG. 7, with an actuating member pivoted through an angle, with the transmission member and the links moved to another angular position, and with the links moved to the second position.

FIG. 12 is a cross sectional view taken along section line 12-12 of FIG 11.

### DETAILED DESCRIPTION OF THE INVENTION

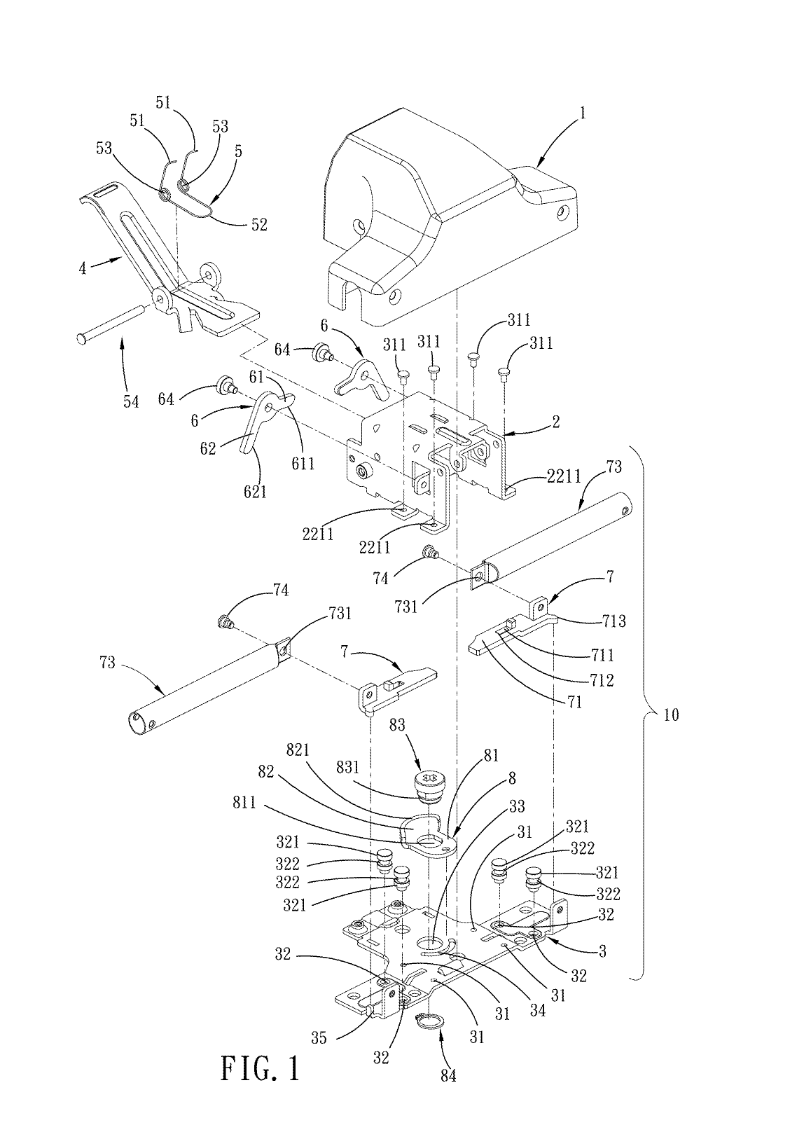

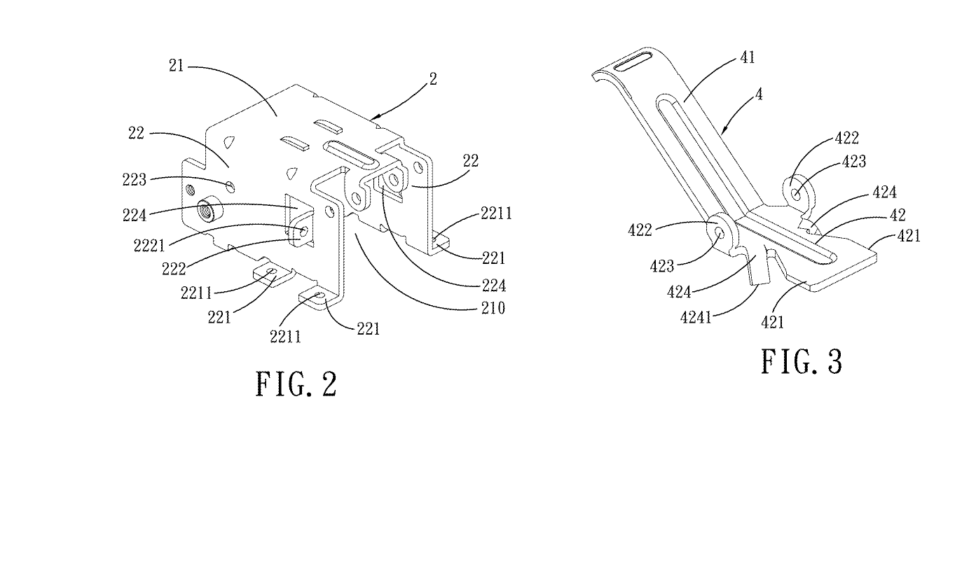

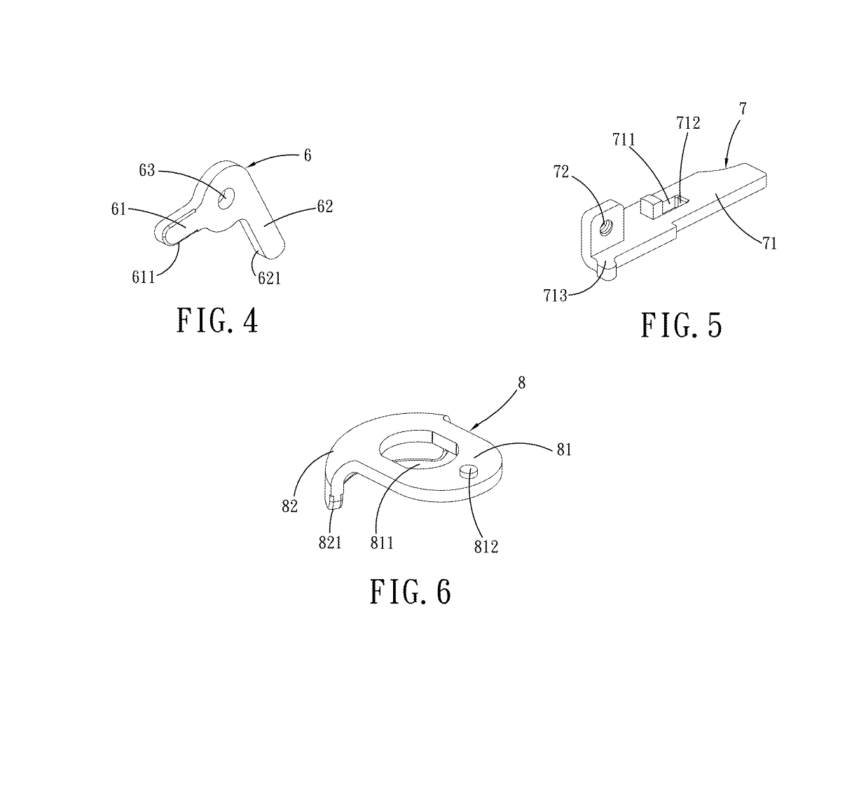

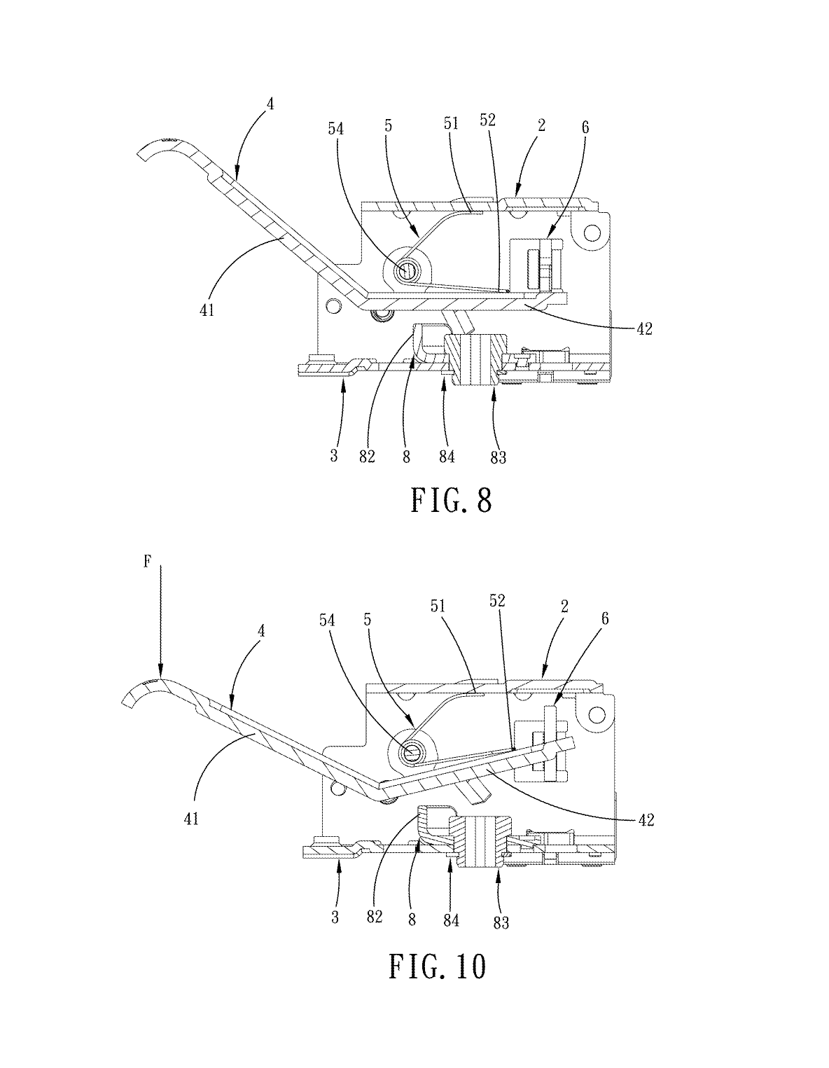

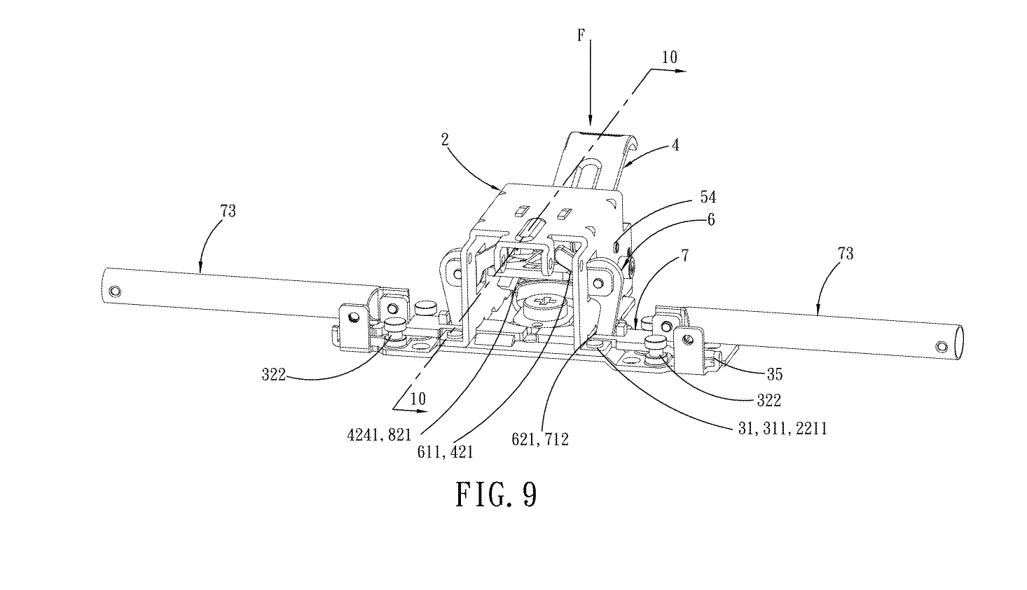

With reference to FIGS. 1-12, a transmission device for an exit device for a door of an embodiment according to the present invention includes a decorative cover 1 mounted to abuse 10. The base 10 includes an upper base 2 and a lower base 3 in the form shown. The upper base 2 is substantially U-shaped in cross section and includes an upper board 21 and two side boards 22 respectively connected to two sides of the upper board 21. A compartment 210 is defined between the upper board 21 and the side boards 22. Two extensions 221 extend from the other side of each side board 22 opposite to the upper board 21. Each extension 221 has a hole 2211. Each side board 22 includes a slot 224 having a side. An extension 222 extends from the side of the slot 224 of each side board 22 and has a hole 2221. Each side board 22 further has a hole paced from the slot 224.

The lower base 3 is substantially T-shaped and includes four first mounting holes 31 and four second mounting holes 32. Two of the first mounting holes 31 are spaced from the other two first mounting holes 31. A pair of the second mounting holes 32 is spaced from the other pair of second mounting holes 32. The lower base 3 further includes a hole 33 and a guiding slot 34. The lower base 3 further includes two ends each having an abutment portion 35. Four limiting members 321 are respectively mounted in the four second mounting holes 32. Each limiting member 31 has a groove 322.

The transmission device further includes a transmission member 4 having a first plate 41 and a second plate 42 connected to and at an angle to the first plate 41. A lug 422 extends upward from each of two sides of the second plate 42 and has a hole 423. A projection 424 extends downward from each side of the second plate 42 and has an actuated portion 4241. A push portion 421 is formed on each of two sides of a distal end of the second plate 42.

The transmission device further includes a return spring 5 including a first end 51, a second end 52, and two coiled portions 53 between the first and second ends 51 and 52. A pin 54 extends through the holes 223 of the side boards 22 of the upper has the holes 423 of the lugs 422 of the transmission member 4, and the coiled portions 53 of the return spring 5. Thus, the transmission member 4, the return spring 5, and the upper base 2 are connected together. The second plate 42 of the transmission member 4 is received in the compartment 210 of the upper base 2. The first end 51 of the return spring 5 abuts the upper board 21 of the upper base 2. The second end 52 of the return spring 5 abuts the second plate 42 of the transmission member 4. The transmission member 4 is pivotable relative to the base 10 between. a first angular position and a second angular position.

The transmission device further includes two driving members 6 each having a first end 61 and a second end 62. The first end 61 of each driving member 6 includes a pushed section 611. The second end 62 of each driving member 6 includes a push section 621. A hole 63 is formed between the first and second ends 61 and 62 of each driving member 6. The first end 61 of each driving member 6 extends through the slot 224 of one of the side boards 22 of the upper base 2 into the compartment 210 of the upper base 2. The holes 63 of the driving members 6 are aligned with the holes 2221 of the extensions 222 of the upper base 2. A pin 64 extends through the hole 63 of each driving member 6 and the hole 2221 of one of the extensions 222 of the base 10 to pivotably mount the driving member 6 to the extension 222 of the base 10. Each driving member 6 is pivotable relative to the base 10 between a third angular position and a fourth angular position. The pushed section 611 of each driving member 6 abuts one of the push portions 421 of the transmission member 4.

The transmission device further includes two links 7 movably mounted to the base 10. Each link 7 is adapted to be connected to a latch of the exit device. Each link 7 includes a bottom board 71 having a groove 711. The groove 711 includes a side forming a pushed portion 712. Each link 7 further includes a screw hole 72 and a stop portion 713 on an end thereof, Each link 7 is movably mounted between two limiting members 321 fixed on two ends of the lower base 3, with the pushed portion 712 of the link 7 located adjacent to the push section 621 of a corresponding driving member 6. Each link 7 includes two lateral sides respectively and movably received in the grooves 322 of two limiting members 321, Each link 7 is movable relative to the base 10 between a first position and a second position. Each latch is adapted to move between a latching position and an unlatching position respectively corresponding to the first and second positions of the corresponding link 7. The stop portion 713 of each link 7 releasably abuts one of the stop portions 35 of the lower base 3. Specifically, when the links 7 are in the first position, the stop portions 713 of the links 7 abut the abutment portions 35 of the lower base 3. On the other hand, when the links 7 are in the second position, the stop portions 713 of the links 7 do not abut the abutment portions 35 of the lower base 3. The transmission device further includes two rods 73 each having a hole 731. A screw 74 extends through the hole 731 of each rod 73 into the screw hole 72 of one of the links 7, fixing the rod 73 to the end of the link 7. In the form shown, one of the rods 73 is adapted to be connected to a top latch, and the other rod 73 is adapted to be connected to a bottom latch. Thus, the links 7 are respectively connected to the top and bottom latches.

The transmission device further includes an actuating member 8 pivotably mounted to the base 10. The actuating member 8 includes a first plate 81 and a second plate 82 connected to the first plate 81. The first plate 81 includes a through-hole 811 and a protrusion 812 received in the guiding slot 34 of the lower base 3. The second plate 82 includes an actuating portion 821. A transmission element 83 extends through the through-hole 811 of the actuating member 8 and the hole 33 of the lower base 3. A retaining ring 84 is mounted in a retaining groove 831 in the transmission element 83 to allow joint rotation of the transmission element 83 and the actuating member 8. When the actuating member 8 pivots relative to the base 10, the protrusion 812 of the actuating member 8 slides in the guiding slot 34 of the lower base 3, restraining the pivoting angle of the actuating member 8. Furthermore, when the actuating member 8 pivots through an angle, the actuating portion 821 of the actuating member 8 pushes one of the actuated portions 4241 of the transmission member 4 to pivot the transmission member 4 from the first angular position to the second angular position.

In assembly, the transmission member 4, the return spring 5, and the driving members 6 are mounted to the upper base 2. Four fasteners 311 extends through the holes 2211 of the upper base 2 and the first mounting holes 31 of the lower base 3 to fix the upper and lower bases 2 and 3 together. The actuated portions 4241 of the transmission member 4 abut the actuating portion 821 of the actuating member 8. The second end 62 of each driving member 6 is received in the groove 711 of one of the links 7. The push section 621 of each driving member 6 is located adjacent to the pushed portion 712 of one of the links 7. Then, the decorative cover 1 is fixed by screws to the upper and lower bases 2 and 3.

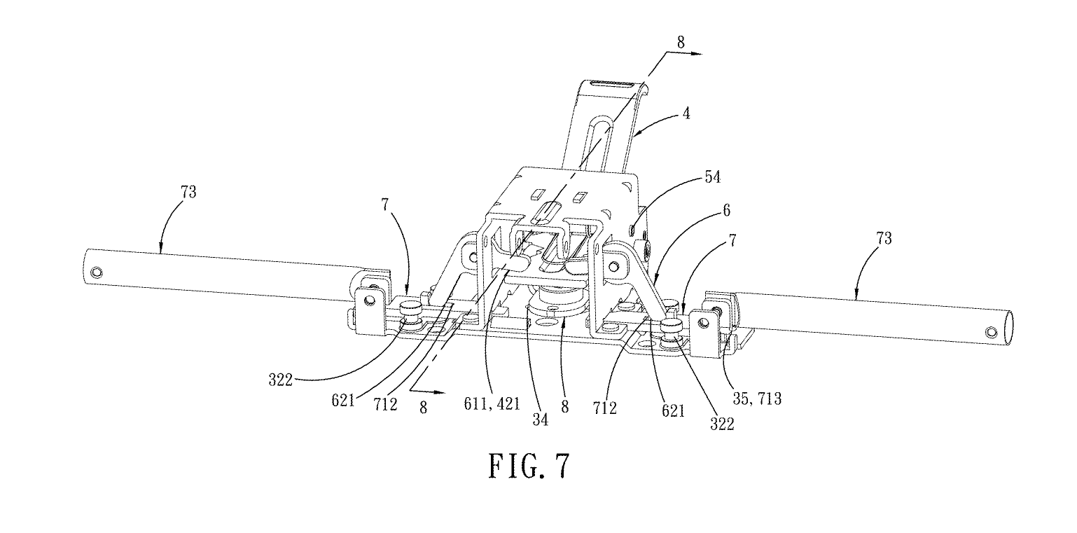

With reference to FIGS. 7-10, when the transmission member 4 is pressed by an external force F and, thus, pivots from the first angular position to the second angular position, the push portions 421 of the transmission member 4 push the pushed sections 611 of the driving members 6 to pivot the driving members 6 from the third angular position to the fourth angular position, and the push sections 621 of the driving members 6 push the pushed portions 712 of the links 7 to move the links 7 from the first position (in which the stop portions 713 of the links 7 abut the abutment portions 35 of the lower base 3) to the second position (in which the stop portions 713 of the links 7 do not abut the abutment portions 35 of the lower base 3). As a result, each of the top and bottom latches connected to the rods 73 moves from an extended position to a retracted position, achieving unlatching purposes.

When the external force F is released, the transmission member 4 returns from the second angular position to the first angular position under the action of the return spring 5. The links 7 return from the second position to the first position by return mechanisms coupled to the rods 73. The pushed portions 712 of the links 7 respectively push the push sections 621 of the driving members 6 to return the driving members 6 from the fourth angular position to the third angular position.

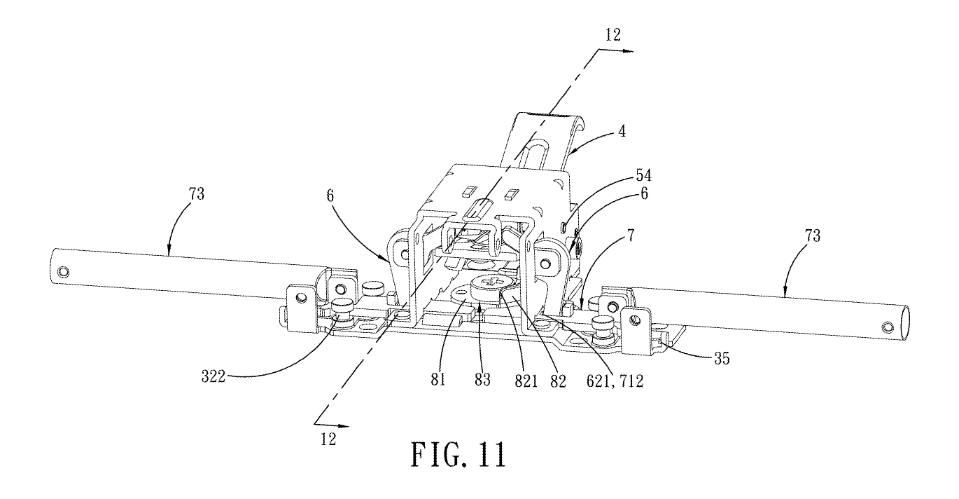

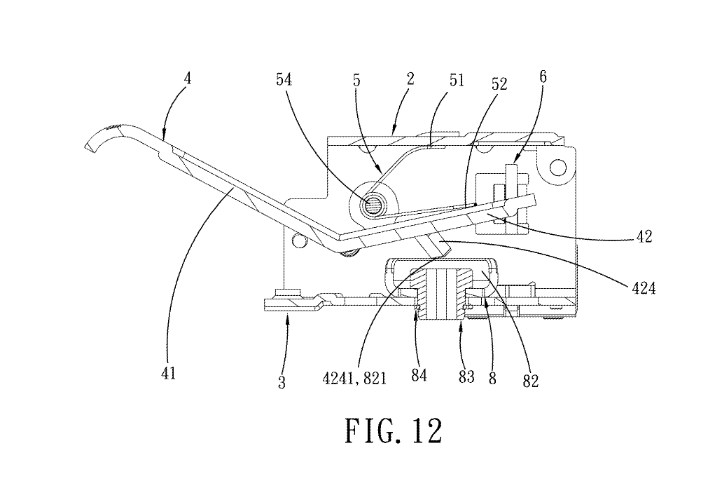

With reference to FIGS. 11 and 12, when the transmission element 83 is pivoted in a direction to pivot actuating member 8 through an angle, the actuating portion 821 of the actuating member 8 pushes the actuated portion 4241 of the transmission member 4 to pivot the transmission member 4 from the first angular position to the second angular position. The push portions 421 of the transmission member 4 push the pushed sections 611 of the driving members 6 to pivot the driving members 6 from the third angular position to the fourth angular position, and the push sections 621 of the driving members 6 push the pushed portions 712 of the links 7 to move the links 7 from the first position (in which the stop portions 713 of the links 7 abut the abutment portions 35 of the lower base 3) to the second position (in which the stop portions 713 of the links 7 do not abut the abutment portions 35 of the lower base 3). As a result, each of the top and bottom latches connected to the rods 73 moves from the extended position to the retracted position, achieving unlatching purposes.

On the other hand, when the transmission element 83 is pivoted in an opposite direction to pivot the actuation member 8 to its initial position, the actuated portions 4241 of the transmission member 4 are no longer pushed by the actuating portion 821 of the actuating member 8 such that the transmission member 4 returns from the second angular position to the first angular position under the action of the return spring 5. The links 7 return from the second position to the first position by return mechanisms coupled to the rods 73. The pushed portions 712 of the links 7 respectively push the push sections 621 of the driving members 6 to return the driving members 6 from the fourth angular position to the third angular position.

In a case that only one latch is used, the transmission device can include only one driving member 6 and only one link 7. The upper base 2 can include only one extension 222 and only one extension 221. The transmission member 4 can include only one lug 422, only one projection 424, and only one push portion 421. The tower base 3 can include only two first mounting holes 31 and only two Second mounting holes 32, and only two limiting members 321. Furthermore, the transmission device can include only one limiting member 321 having a groove 322 to guide movement of the link 7. Further, the transmission device does not have to include the decorative cover 1.

Although specific embodiments have been illustrated and described, numerous modifications and variations are still possible without departing from the scope of the invention. The scope of the invention is limited by the accompanying claims.

What is claimed is:

1 A transmission device for an exit device for a door comprising:
a base including an extension;
a transmission member pivotably mounted to the base, with the transmission member pivotable relative to the base between a first angular position and a second angular position, with the transmission member including a push portion;
a driving member pivotably mounted to the extension of the base, with the driving member pivotable relative to the base between a third angular position and a fourth angular position, with the driving member including a pushed section and a push section, with the pushed section of the driving member abutting the push portion of the transmission member; and
a link movably mounted to the base, with the link adapted to be connected to a latch of an exit device for a door, with the link movable relative to the base between a first position and a second position, with the latch adapted to move between a latching position and an unlatching position respectively corresponding to the first and second positions of the link, with the link including a pushed portion located adjacent to the push section of the driving member,
wherein when the transmission member pivots from the first angular position to the second angular position, the push portion of the transmission member pushes the pushed section of the driving member to pivot the driving member from the third angular position to the fourth angular position, and the push section of the driving member pushes the pushed portion of the link to move the link from the first position to the second position.

2. The transmission device as claimed in claim 1, with the base including a slot, with the driving member including a first end extending through the slot of the base, with the first end of the driving member including the pushed section of the driving member.

3. The transmission device as claimed in claim 2, with the slot of the base including a side, with the extension of the base extending from the side of the slot of the base, with the extension including a hole, with the driving member including a hole, with a pin extending through the hole of the driving member and the hole of the extension of the base to pivotably mount the driving member to the base.

4. The transmission device as claimed in claim 1, with the transmission member including a first plate and a second plate connected to and at an angle to the first plate, with the second plate of the transmission member including the push portion of the transmission member.

5. The transmission device as claimed in claim 2, with the link including a groove having a wall forming the pushed portion of the link, with the driving member further including a second end received in the groove of the link, with the second end of the driving member including the push section of the driving member.

6. The transmission device as claimed in claim 1, with the link further including a stop portion, with the base further including an abutment portion,
wherein when the link is in the first position, the stop portion of the link abuts the abutment portion of the base, and
wherein when the link is in the second position, the stop portion of the link does not abut the abutment portion of the base.

7. The transmission device as claimed in claim 1, with the link including an end having a screw hole, with the transmission device further comprising: a rod including a hole; and a screw extending through the hole of the rod into the screw hole of the link, fixing the rod to the end of the link, with the rod adapted to be connected to the latch.

8. The transmission device as claimed in claim 1, further comprising: two limiting members, with the base including two mounting holes, with the two limiting members respectively mounted in the two mounting holes of the base, with each of the two limiting members including a groove, with the link including two lateral sides respectively and movably received in the grooves of the two limiting members.

9. The transmission device as claimed in claim 1, further comprising: an actuating member pivotably mounted to the base, with the actuating member including an actuating portion, with the transmission member including an actuated portion, wherein when the actuating member pivots through an angle, the actuating portion of the actuating member pushes the actuated portion of the transmission member to pivot the transmission member from the first angular position to the second angular position.

10. The transmission device as claimed in claim 9, with the actuating member further including a protrusion, with the base including a guiding slot, with the protrusion of the actuating member slides in the guiding slot when the actuating member pivots relative to the base.

11. A transmission device for an exit device for a door comprising:
a base including an extension;
a transmission member pivotably mounted to the base, with the transmission member pivotable relative to the base between a first angular position and a second angular position, with the transmission member including a push portion;
a driving member pivotably mounted to the extension of the base, with the driving member pivotable relative to the base between a third angular position and a fourth angular position, with the driving member including a pushed section and a push section, with the pushed section of the driving member abutting the push portion of the transmission member;
a link movably mounted to the base, with the link adapted to be connected to a latch of an exit device for a door, with the link movable relative to the base between a first position and a second position, with the latch adapted to move between a latching position and an unlatching position respectively corresponding to the first and second positions of the link, with the link including a pushed portion located adjacent to the push section of the driving member; and
at least one limiting member mounted to the base and including a groove, with the link including a lateral side movably received in the groove of the at least one limiting member,
wherein when the transmission member pivots from the first angular position to the second angular position, the push portion of the transmission member pushes the pushed section of the driving member to pivot the driving member from the third angular position to the fourth angular position, and the push section of the driving member pushes the pushed portion of the link to move the link from the first position to the second position.

12. The transmission device as claimed in claim 11, with the transmission member including a first plate and a second plate connected to and at an angle to the first plate, with the second plate of the transmission member including the push portion of the transmission member.

13. The transmission device as claimed in claim 11, further comprising: an actuating member pivotably mounted to the base, with the actuating member including an actuating portion, with the transmission member including an actuated portion, wherein when the actuating member pivots through an angle, the actuating portion of the actuating member pushes the actuated portion of the transmission member to pivot the transmission member from the first angular position to the second angular position.

14. The transmission device as claimed in claim 13, with the actuating member further including a protrusion, with the base including a guiding slot, with the protrusion of the actuating member slides in the guiding slot when the actuating member pivots relative to the base.

15. A transmission device for an exit device for a door comprising:
a base including a slot having a side, with an extension extending from the side of the slot of the base and having a hole;
a transmission member pivotably mounted to the base, with the transmission member pivotable relative to the base between a first angular position and a second angular position, with the transmission member including a push portion;
a driving member pivotably mounted to the extension of the base, with the driving member pivotable relative to the base between a third angular position and a fourth angular position, with the driving member including a first end, a push section, and a hole, with the first end of the driving member including a pushed section, with the first end of the driving member extending through the slot of the base, with the pushed section of the driving member abutting the push portion of the transmission member;
a pin extending through the hole of the driving member and the hole of the extension of the base to pivotably mount the driving member to the base;
a link movably mounted to the base, with the link adapted to be connected to a latch of an exit device for a door, with the link movable relative to the base between a first position and a second position, with the latch adapted to move between a latching position and an unlatching position respectively corresponding to the first and second positions of the link, with the link including a pushed portion located adjacent to the push section of the driving member; and
at least one limiting member mounted to the base and including a groove, with the link including a lateral side movably received in the groove of the at least one limiting member,
wherein when the transmission member pivots from the first angular position to the second angular position, the push portion of the transmission member pushes the pushed section of the driving member to pivot the driving member from the third angular position to the fourth angular position, and the push section of the driving member pushes the pushed portion of the link to move the link from the first position to the second position.

16. The transmission device as claimed in claim 15, with the transmission member including a first plate and a second plate connected to and at an angle to the first plate, with the second plate of the transmission member including the push portion of the transmission member.

17. The transmission device as claimed in claim 15, further comprising: an actuating member pivotably mounted to the base, with the actuating member including an actuating portion, with the transmission member including an actuated portion, wherein when the actuating member pivots through an angle, the actuating portion of the actuating member pushes the actuated portion of the transmission member to pivot the transmission member from the first angular position to the second angular position.

18. The transmission device as claimed in claim 17, with the actuating member further including a protrusion, with the base including a guiding slot, with the protrusion of the actuating member slides in the guiding slot when the actuating member pivots relative to the base.
